(19) United States
(12) Patent Application Publication
(10) Pub. No.: US 2016/0008848 A1
(43) Pub. Date: Jan. 14, 2016

(54) UVA CURING PROCESS AND SYSTEM FOR COLLISION AND COSMETIC REPAIRS OF AUTOMOBILES

(71) Applicant: AXALTA COATING SYSTEM IP CO. LLC, Wilmington, DE (US)

(72) Inventor: John Charles LARSON, West Chester, PA (US)

(73) Assignee: AXALTA COATING SYSTEMS IP CO., LLC, Wilmington, DE (US)

(21) Appl. No.: 14/771,695

(22) PCT Filed: Feb. 28, 2014
(86) PCT No.: PCT/US2014/019387

§ 371 Date: Aug. 31, 2015

Related U.S. Application Data
(60) Provisional application No. 61/771,176, filed on Mar. 1, 2013.

(51) Int. Cl. B05D 3/06

(52) U.S. Cl. CPC B05D 3/067

(57) ABSTRACT

A process for producing a dry coating layer over a substrate is provided. The process can comprise irradiating a radiation curable wet coating layer applied over the substrate with a high power mobile radiation device at a predetermined linear velocity along the surface of the substrate and at a predetermined curing distance. The mobile radiation device can produce radiation having peak radiation wavelength in a range of from 250 nm to 450 nm and can have a peak irradiation power in a range of from 0.5 W/cm² to 10 W/cm². The wet coating layer can be cured within a few seconds to a few minutes. The cured dry coating layer is free from curing defects. The process and the system disclosed herein can be used for vehicle coating refinish and repairs, especially for collision and cosmetic repairs of automobiles.

### CROSS-REFERENCE TO RELATED APPLICATION

This application is a U.S. National-Stage entry under 35 U.S.C. §371 based on International Application No. PCT/US2014/019387, filed Feb. 28, 2014, which was published under PCT Article 21(2) and which claims the benefit of U.S. Provisional Application No. 61/771,176, filed Mar. 1, 2013, which is incorporated herein by reference in its entirety.

### TECHNICAL FIELD

The present disclosure is directed to a process producing a dry coating layer over a coated area of a substrate. This disclosure is further directed to a mobile radiation system for curing a radiation curable coating composition to form a cured coating layer.

### BACKGROUND

The use of radiation curable coatings is becoming more common in the coating industry. Such use requires a combination of radiation curable coating compositions and a radiation source. Typically, an ultraviolet (UV) source such as a UV lamp can be used for curing a UV curable coating composition applied over a substrate to form a cured coating layer. However, the radiation such as the UV radiation from the UV lamp can be harmful for operators during the use.

Therefore, it is desirable to provide an improved radiation process and system. In addition, other objects, desirable features and characteristics will become apparent from the subsequent summary and detailed description, and the appended claims, taken in conjunction with the accompanying drawings and this background.

### SUMMARY

According to an exemplary embodiment, a process for producing a dry coating layer over a coated area of a substrate is provided. The comprises the steps of:
A) irradiating a first portion of a wet coating layer over said coated area with a mobile radiation device, said wet coating layer is formed from a radiation curable coating composition applied over said coated area of said substrate; and
B) irradiating one or more subsequent portions of said wet coating layer by moving said mobile radiation device from said first portion to said one or more subsequent portions, and optionally repeating irradiating said first portion and said one or more subsequent portions, until said wet coating layer is irradiated for a predetermined curing time to form said dry coating layer;
wherein said mobile radiation device is moved at a predetermined linear velocity along the surface of said substrate at a predetermined curing distance between said mobile radiation device and the surface of said substrate; and
said mobile radiation device produces radiation having peak radiation wavelength in a range of from 250 nm to 450 nm and has a peak irradiation power in a range of from 0.5 W/cm² to 10 W/cm².

In accordance with another exemplary embodiment a smart radiation curing system is provided. The smart radiation curing system comprises:
(a1) a mobile radiation device (3);
(a2) a power and control unit (4) coupled to said mobile radiation device; and
(a3) at least one distance indicator (5) for generating a distance signal based on a pre-determined curing distance and an actual distance between said mobile radiation device and the surface of a substrate.

In accordance with a further exemplary embodiment, a kit for the smart radiation curing system is provided.

### BRIEF DESCRIPTION OF DRAWINGS

The present invention will hereinafter be described in conjunction with the following drawing figures, wherein like numerals denote like elements, and:

FIG. 1 shows a schematic presentation of an example of the process.

FIGS. 2A through 2D show schematic presentations of examples of the process: (A) an example of patterns for moving the mobile radiation device; (B) another example of patterns for moving the mobile radiation device; (C) a further example of patterns for moving the mobile radiation device; and (D) a schematic presentation of a system having a substrate support system.

FIGS. 3A through 3C show schematic presentations of examples of the process and system: (A) one or more distance indicators affixed to the mobile radiation device; (B) one or more mobile radiation devices affixed to the substrate; and (C) one or more mobile radiation devices or parts thereof affixed to the mobile radiation device and the substrate.

FIGS. 4A through 4C show schematic presentations of examples of the process and system having an optical distance indicator: (A) distance indicator light beam indicating the correct distance between the mobile radiation device and the substrate; (B) distance indicator light beam indicating the distance being too far; and (C) distance indicator light beam indicating the distance being too close.

FIGS. 5A through 5C show schematic cross-sectional presentations of examples of the mobile radiation device having: (A) a vent fan and a shutter system; (B) a radiation reflector; and (C) a radiation area over a substrate.

FIGS. 6A through 6C show schematic cross-sectional presentations of examples of the mobile radiation device having: (A) two distance indicators affixed to the mobile radiation device; (B) a distance indicator having two parts one being affixed to the mobile radiation device and one being affixed to a stationary base; and (C) two distance indicators each having two parts, one being affixed to the mobile radiation device and one being affixed to a stationary base.

FIGS. 7A through 7D show schematic cross-sectional presentations of examples of the distance indicator having: (A) an optical device; (B) a distance measuring device, an audio device, a vibration device and a display device; (C) additional display and/or computing device; and (D) additional one or more wired or wireless network devices.

FIGS. 8A through 8B show schematic cross-sectional presentations of examples of the system having: (A) a flexible guiding rail device and a guiding rail coupler; and (B) a supporting arm and motion support device.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

A “coated substrate” refers to a substrate covered with a coating, or multiple coatings. A coating or coatings can be a primer, a pigmented basecoat, a topcoat, or a clearcoat. The substrate can be covered by multiple layers of two different coatings, such as one or more layers of primers and one or more layers of pigmented basecoats as topcoats. The substrate can also be covered by multiple layers of at least three different coatings, such as one or more layers of primers, one or more layers of pigmented basecoats, and one or more layers of un-colored clearcoats. Examples of coated substrates can be a vehicle body or body parts coated with one or more monocolor paints, a vehicle body or body parts coated with one or more metallic paints, a bicycle body or body parts coated with one or more paints, a boat or boat parts coated with one or more paints, furniture or furniture parts coated with one or more paints, an airplane coated with one or more paints. The substrate can be made of metal, wood, plastic or other natural or synthetic materials.

As used herein “vehicle” includes an automobile, such as car, bus, truck, semi truck, pickup truck, SUV (Sports Utility Vehicle); tractor; motorcycle; trailer; ATV (all terrain vehicle); heavy duty mover, such as, bulldozer, mobile crane and earth mover; airplanes; boats; ships; and other modes of transport that are coated with coating compositions.

The phrase “tacky” means when the surface of a cured coating is touched with an object such as, a dry finger, gauze, or cotton swab, visible marks appear on the surface. The tacky layer may be fluid enough to flow and consequently heal, such that any visible marks on the surface of the tacky layer are no longer visible. Tackiness can be the consequence of a layer that has not fully cured and is thus not preferred in the refinish applications. Therefore, tacky material from the surface of a coating needs to be further cured or removed prior to sanding said coating layer or prior to applying subsequent coating layers over the tacky coating layer.

The term “radiation”, “irradiation” or “actinic radiation” means radiation that causes, in the presence of a photoinitiator, polymerization of monomers that have ethylenically unsaturated double bonds, such as acrylic or methacrylic double bonds. Sources of actinic radiation may be natural sunlight or artificial radiation sources. Examples of actinic radiation include, but not limited to, UV-A radiation, which falls within the wavelength range of from 320 nanometers (nm) to 400 nm; UV-B radiation, which is radiation having a wavelength falling in the range of from 280 nm to 320 nm; UV-C radiation, which is radiation having a wavelength falling in the range of from 100 nm to 280 nm; and UV-V radiation, which is radiation having a wavelength falling in the range of from 400 nm to 800 nm. Other examples of radiation can include electron-beam, also known as e-beam. Many artificial radiation sources emit a spectrum of radiation that contains UV radiation having wavelengths shorter than 320 nm. Actinic radiation of wavelengths shorter than 320 nm emits high energy and can cause damage to the skin and eyes. Radiations with longer wavelengths, such as UV-A or UV-V, emit lower energy and are considered safer than radiations with shorter wavelengths, such as UV-C or UV-B.

A radiation curable coating composition can be any coating compositions that can be cured to form a cured dry coating by the radiation. For example a UV mono-cure coating composition, can be prepared to form a pot mix and stored in a sealed container. As long as said UV mono-cure coating composition is not exposed to UV radiation, said UV mono-cure coating composition can have indefinite pot life.

This disclosure is directed to a process for producing a dry coating layer over a coated area of a substrate (1). The process can comprise the steps of:

A) irradiating a first portion of a wet coating layer (2) over the coated area with a mobile radiation device, the wet coating layer is formed from a radiation curable coating composition applied over the coated area of the substrate; and

B) irradiating one or more subsequent portions of the wet coating layer by moving the mobile radiation device from the first portion to the one or more subsequent portions, and optionally repeating irradiating the first portion and the one or more subsequent portions, until the wet coating layer is irradiated for a predetermined curing time to form the dry coating layer;

wherein the mobile radiation device is moved at a predetermined linear velocity along the surface of the substrate at a predetermined curing distance between the mobile radiation device and the surface of the substrate; and

the mobile radiation device produces radiation having peak radiation wavelength in a range of from 250 nm to 450 nm and has a peak irradiation power in a range of from 0.5 W/cm² to 10 W/cm².

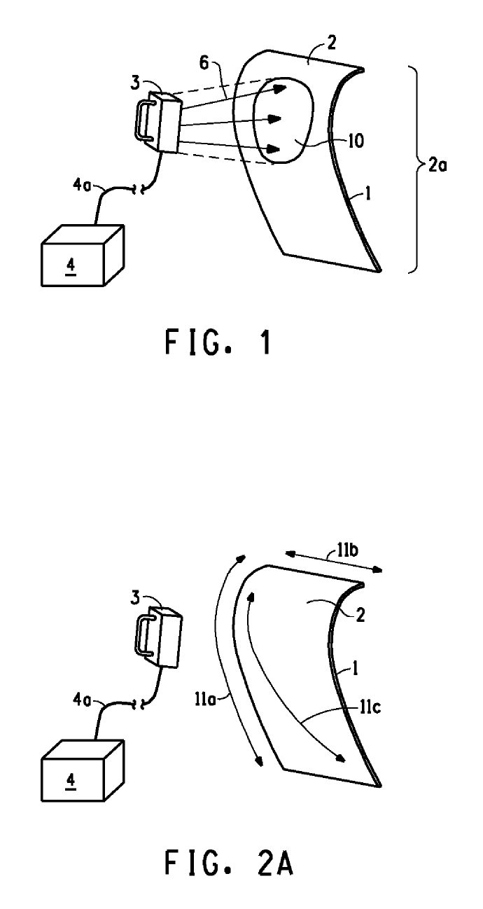

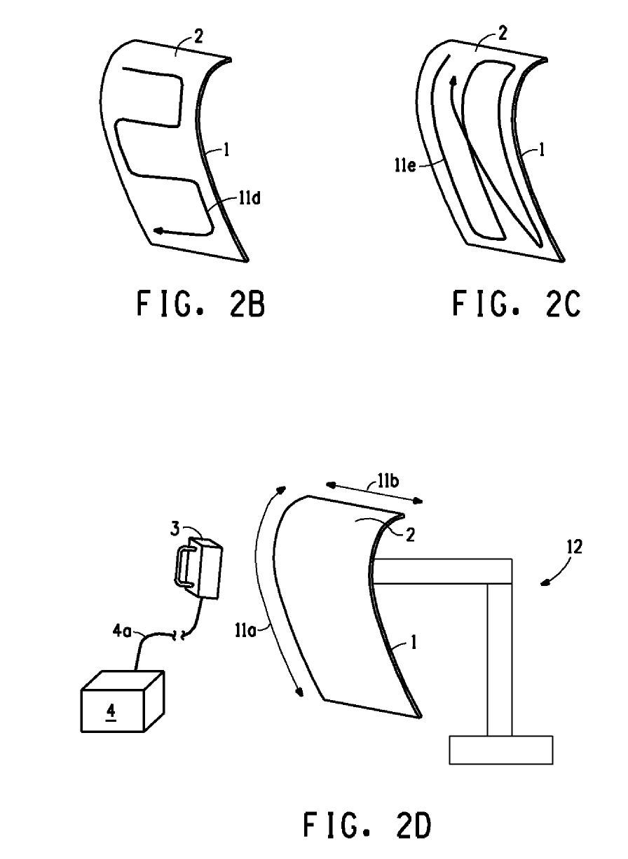

The mobile radiation device (3) can be moved in different moving patterns and directions at a predetermined linear velocity along the surface of the substrate at a predetermined curing distance between the mobile radiation device and the surface of the substrate to provide UV radiation (6). The mobile radiation device (3) can be coupled to a power and control unit (4) via one or more power and control connection devices (4a) (FIG. 1). Examples of moving patterns can include bi-directional pattern (11b-11c) (FIG. 2A), zigzag pattern (11d) (FIG. 2B), a combination pattern (11e) (FIG. 2C), or any other moving patterns that determined necessary.

The substrate can be supported with a substrate support system (12). Examples of the substrate support system can include a fixed arm, a flexible arm, a frame, a hanger, any other supporting structures that position the substrate at a position in space, or a combination thereof.

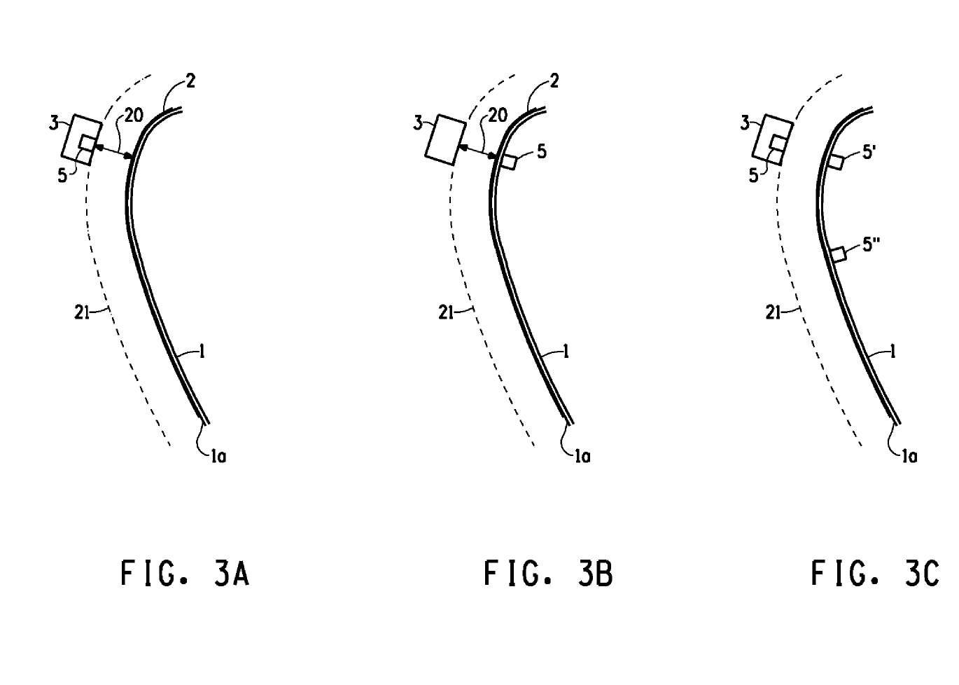

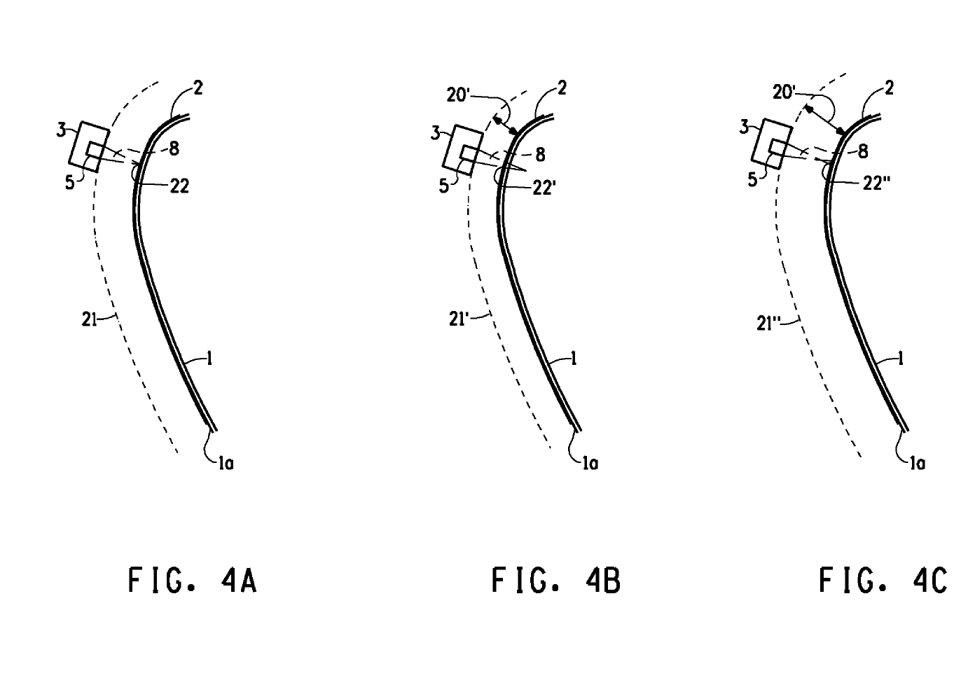

The predetermined curing distance (20) between the mobile radiation device and the surface of the substrate can be determined or monitored with a distance indicator (5) and any parts (5′) thereof when present. The mobile radiation device can be moved along a predetermined track (21) (FIG. 3A-3C). In one example an optical device can be used as the distance indicator to provide a light beam (8) producing a correct indication area (22) indicating the distance between the mobile radiation device and the surface of the substrate are within the predetermined curing distance (FIG. 4A). When the mobile radiation device is too close to the substrate along a near track (21′), the light beam (8) can produce an out-of range indication area (22′) indicating an actual distance (20′) is too close (FIG. 4B). When the mobile radiation device is too far to the substrate along a far track (21″), the light beam (8) can produce another out-of range indication area (22″) indicating an actual distance (20′) is too far (FIG. 4C).

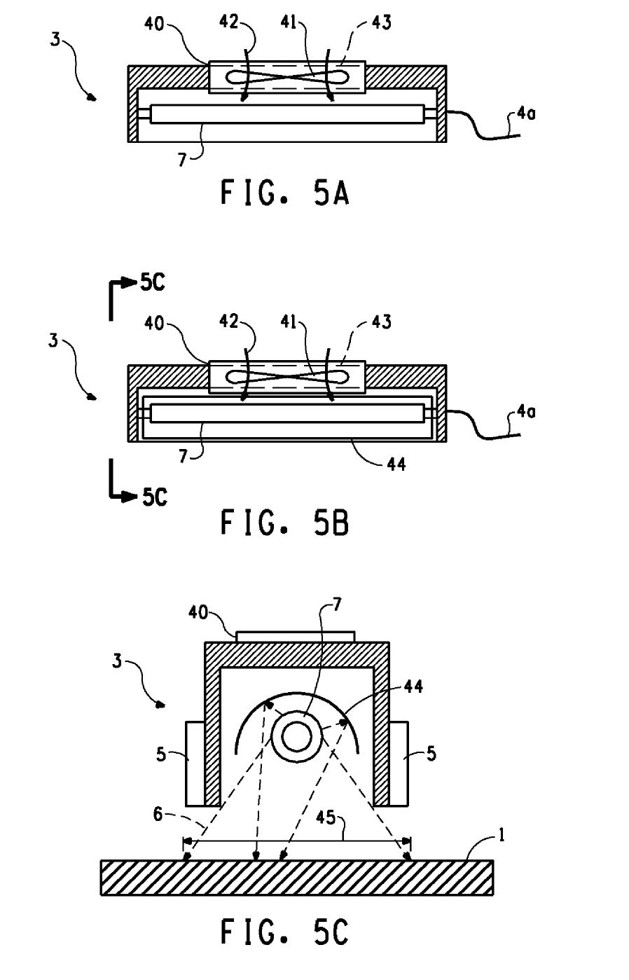

The mobile radiation device (3) can comprise a UV source such as a UV light bulb (7) (FIG. 5A-5C) such as a mercury UV lamp, a UV light-emitting diode (LED), or any other UV source that can provide the desired irradiation power at the target coating. A UV power measuring device, such as a UV POWER PUCK® FLASH, available from The EIT Instrument, Sterling, Va. 20164, USA, under respective registered trademark, can be suitable to measure UV irradiation power. In one example, a UVA device that can produce UVA radiation can be suitable.

In the process disclosed herein, the wet coating layer can be irradiated at a pre-determined radiation energy in a range of from 100 mJ/cm² to 2000 mJ/cm² measured at the surface of the substrate.

The predetermined curing distance (20) can be in a range of from 1 cm to 50 cm.

The curing time can be in a range of from 10 second to 20 minutes.

The predetermined linear velocity is in a range of from 1 cm/second to 100 cm/second.

In the process disclosed herein, the coated area is greater than the maximum effective radiation area of the mobile radiation device. An effective radiation area (10) of the mobile radiation device is the maximum area that the mobile radiation device can deliver the aforementioned radiation energy measured at the surface of the substrate. The effective radiation area (10) can be affected or adjusted by using different power, different distance between the mobile radiation device and the substrate, different size or geometry of a radiation reflector (44), radiation time, or a combination thereof. In one example, the effective radiation area can be the radiation area (45) (FIG. 5C).

The process can further comprise the step of:

C) generating a distance signal using at least one distance indicator indicating a difference between the pre-determined curing distance and an actual distance between the mobile radiation device and the surface of the substrate.

The distance signal can be generated as a visual signal, an audio signal, a vibration signal, an electronic signal, or a combination thereof.

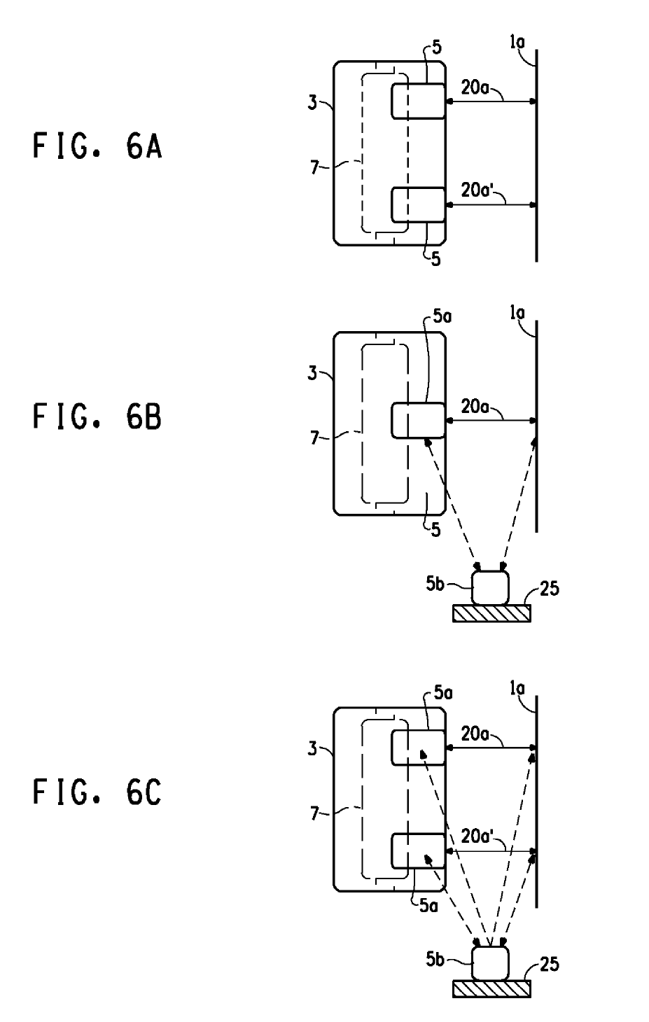

In the process disclosed herein, at least one distance indicator (5 or 5a) or a part thereof (5′, 5″ or 5b) can be configured to be affixed to the mobile radiation device (see at least FIG. 3A, FIG. 3C, FIG. 4 and FIG. 6A-6C), positioned on the surface of the substrate (See at least FIG. 3B and FIG. 3C), positioned at a stationary base coupled to the mobile radiation device, positioned at a stationary base coupled to the substrate, positioned at a stand-alone stationary base (FIG. 6B and FIG. 6C), or a combination thereof. The stationary base (25) can be coupled to the mobile radiation device, coupled to the substrate, or stand-along.

In the process disclosed herein, the distance signal can be generated by a distance determination process comprising the steps of:

C1) measuring the actual distance between the mobile radiation device and the surface of the substrate using a distance measuring device; and

C2) comparing the actual distance with the pre-determined curing distance to generate the distance signal.

The distance measuring device can be selected from an ultrasonic distance measuring device, an optical distance measuring device, a laser distance measuring device, a radar distance measuring device, or a combination thereof.

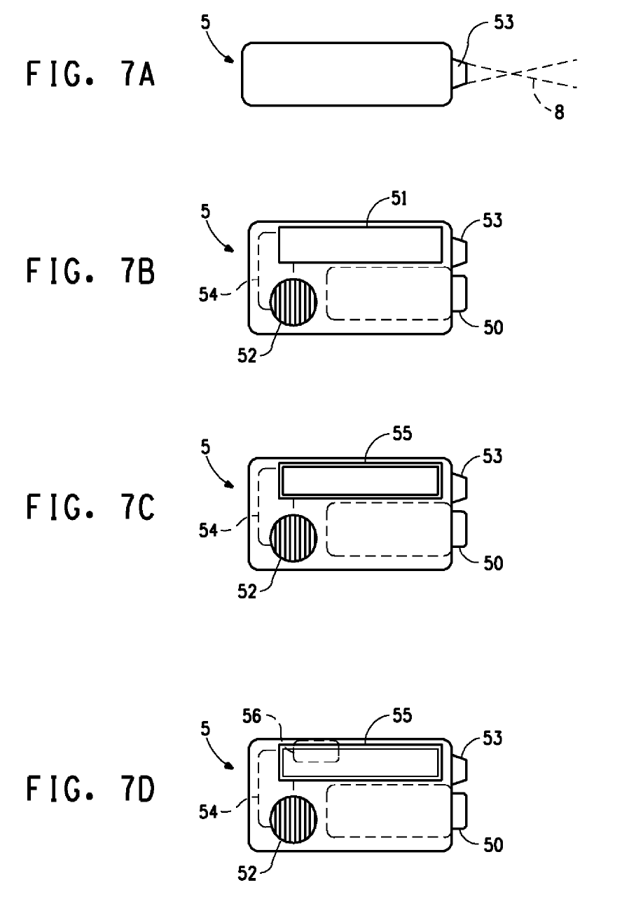

A computing device can be used to receive data on the actual distance and to generate the distance signal by comparing the actual distance with the pre-determined curing distance. In one example, the computing device can be part of the distance indicator, such as the display and computing device (55) of the distance indicator (FIG. 7).

The distance measuring device, the distance indicator and other devices can be configured as a single device. In one example, the distance indicator (5) can comprise an optical device (53) (FIG. 7A). In another example, the distance indicator can comprise the optical device (53), a distance measuring device (50), a display device (51), an audio device (52), a vibration device (54), or a combination thereof (FIG. 7B). In yet another example the distance indicator can further comprise a computing device (55) (FIG. 7C), wherein said computing device can optionally comprise a display device. In yet another example the distance indicator can further comprise a wired or wireless network device (56) (FIG. 7D).

The process can further comprise the step of:

D) providing motion to the mobile radiation device moving along the surface of the substrate based on the distance signal maintaining the actual distance within a predetermined distance tolerance range of the pre-determined curing distance.

The mobile radiation device can be configured to be affixed to a motion support device that is configured to support the mobile radiation device and provide motion to the mobile radiation device at the predetermined linear velocity and within the predetermined distance tolerance range based on the distance signal.

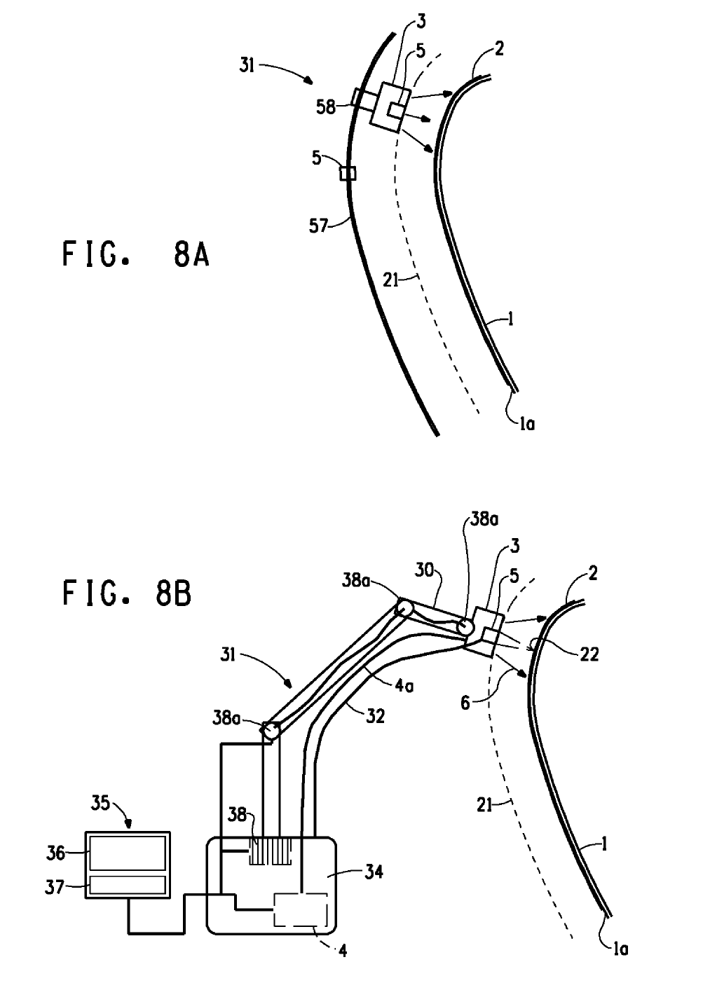

In one example, the mobile radiation device can be moved along the surface of the substrate using a flexible guiding rail device (57) and a guiding rail coupler (58) (FIG. 8A). The mobile radiation device can be moved by an operator or by a motor based on a motion signal. In another example, the mobile radiation device can be moved along the surface of the substrate using a supporting arm (30) and a motion support device (31) (FIG. 8B). The mobile radiation device can be moved by motion devices (38) and (38a), such as one or more motors, for positioning the radiation device based on a distance signal, a motion signal, or a combination thereof. The motion devices can be coupled with the distance indicator via one or more distance indicator couplers (32).

The mobile radiation device can be moved by an operator or by a motion device based on the distance signal, the motion signal, or a combination thereof.

The motion support device can be configured to move the mobile radiation device according to the surface geometry of the substrate. In one example the substrate has a curved surface (1a) and the motion support device can be configured to move the mobile radiation device according to the surface geometry of the substrate along the predetermined track (21) (FIG. 8B).

When radiation power is constant, the radiation energy delivered to the coating by the mobile radiation device can be affected by the distance between the mobile radiation device and the coating layer. Portions of the coating layer cured with different radiation energy can have different visual effects showing as visible curing defects, such as lines, spots, or a combination thereof, that are visually visible under some illumination conditions.

The dry coating layer produced with the process disclosed herein can be free from visible curing defect as viewed under defused illumination over the dry coating layer. The process disclosed herein provides constant distance between the mobile radiation device and the substrate therefore delivering constant radiation energy to the wet coating resulting in constant coating appearance free from the aforementioned visible curing defects.

The process disclosed herein can further comprise the steps of:

A1) applying an curing indicator on the surface of the substrate before the step A);

A2) irradiating the curing indicator with the mobile radiation device at the predetermined curing distance for the predetermined curing time;

A3) measuring one or more measured curing characteristics of the curing indicator and comparing the one or more measured curing characteristics with one or more predetermined curing characteristics to produce curing difference data values;

A4) adjusting the curing time to produce an adjusted curing time, adjusting the curing distance to produce an adjusted curing distance, or a combination thereof, if the curing difference data values are not within a predetermined curing tolerance range;

A5) optionally, repeating the steps of A1)-A5) to produce subsequent adjusted curing time, subsequent adjusted curing distance, or a combination thereof until curing difference data values are within the predetermined curing tolerance range; and

A6) continuing to the step A) and subsequent steps by replacing the curing time with the adjust curing time or the subsequent adjusted curing time if present, replacing the curing distance with the adjusted curing distance or the subsequent adjusted curing distance if present, or a combination thereof.

The curing indicator can be a wet specimen coating layer formed from the radiation curable coating composition to be tested. In one example, a layer of the radiation curable coating composition can be applied over a small area of the substrate to form the curing indicator.

After curing, coating properties, such as hardness, tacky, gloss, or a combination thereof, can be measured as the measured curing characteristics and can be compared to predetermined curing characteristics.

The aforementioned step can be used to produce the predetermined curing time, the curing distance, the velocity, or a combination thereof.

This disclosure is further directed to a smart radiation curing system. The smart radiation curing system can comprise:

(a1) a mobile radiation device (3);

(a2) a power and control unit (4) coupled to the mobile radiation device; and

(a3) at least one distance indicator (5) for generating a distance signal based on a pre-determined curing distance and an actual distance between the mobile radiation device and the surface of a substrate.

The distance indicator (5) can comprise a visual signal device for generating a visual signal, an audio signal device for generating an audio signal, a vibration signal device for generating a vibration signal, a digital signal device for generating an electronic signal, or a combination thereof. The distance indicator (5) or parts (5′, 5″ or 5b) thereof can be affixed to the mobile radiation device, capable of being positioned on the surface of the substrate, capable of being positioned at a stationary base coupled to the mobile radiation device, capable of being positioned at a stationary base coupled to the substrate, or a combination thereof (FIG. 3A-3C, FIG. 4A-4C, FIG. 5C, FIG. 6A-6C).

In the system disclosed herein, when one or more distance indicators are present, at least one distance indicator (5) can comprise a display device (51 or 55), a wired or wireless network device (56), or a combination thereof (FIG. 6 and FIG. 7). At least one distance indicator (5) can comprise at least a distance measuring device (50) for measuring the actual distance between the mobile radiation device and the surface of the substrate, and the distance measuring device can be selected from an ultrasonic distance measuring device, an optical distance measuring device, a laser distance measuring device, a radar distance measuring device, or a combination thereof (FIG. 7B-7D).

The system can further comprise:

(a4) a motion support device (31) that is coupled to the mobile radiation device, wherein the motion support device (31) can be configured to maintain the actual distance within a predetermined distance tolerance range of the pre-determined curing distance when the mobile radiation device is moving along the surface of the substrate (FIG. 8A-8B).

The motion support device (31) can be a guiding rail device, an arm device, or a combination thereof, wherein the motion support device can be configured to fit the surface geometry of the substrate. In one example, the motion support device can be a flexible guiding rail device or a pre-configured rigid guiding rail device (57) for maintaining the curing distance while the mobile radiation device is being moved for providing the radiation to the substrate and the coating thereon (FIG. 8A). A guiding rail coupler (58) can be used to couple the mobile radiation device to the guiding rail device. In another example, the motion support device can comprise a supporting arm (30), a distance indicator (5), a distance indicator coupler (32), and a supporting base (34). The motion support device can comprise a base computing device (35) having at least one base computer display device (36) and at least a base computer input device (37), one or more motion devices (38, 38a) coupled to the supporting arm (30), wherein said base computing device (35) can be functionally coupled to the power and control unit (4) and the distance indicator (5) via the distance indicator coupler (32), and wherein the base computing device (35) can be configured to receive a distance signal from the distance indicator (5) and to generate a motion signal for controlling the one or more motion devices (38, 38a) to move the supporting arm (30) and the mobile radiation device for positioning the radiation device based on the motion signal.

The system can further comprise a computing device functionally coupled to the support device, the mobile radiation device, the distance measuring device, or a combination thereof. The system computing device can be functionally coupled to a first computer program product comprising computer executable codes stored on a computer readable storage device and, when in operational, to cause the computing device to perform a computing process comprising the steps of:

C1) obtaining the actual distance between the mobile radiation device and the surface of the substrate from the distance measuring device;

C2) comparing the actual distance with the pre-determined curing distance to generate the distance signal;

C3) obtaining a predetermined linear velocity and moving path data from an input device (37) coupled to the computing device;

C3) generating motion signals for moving the mobile radiation device based on the distance signal, the predetermined distance tolerance range of the pre-determined curing distance, the predetermined linear velocity and the moving path data.

The computing device and the base computing device can be the same or different. The computing device can be positioned in proximity to the motion support device, or positioned in a remote location and being coupled to the motion support device via one or more wired or wireless connections or network devices.

The motion support device (31) can be a motorized device configured to automatically move the mobile radiation device along the surface of the substrate based on the motion signal.

This disclosure is further directed to a kit for a smart radiation curing system. The kit can comprise:

i) a mobile radiation device (3);

ii) a power and control unit (4) connectable to the mobile radiation device; and

iii) at least one distance indicator (5) for generating a distance signal based on a pre-determined curing distance and an actual distance between the mobile radiation device and the surface of a substrate;

wherein the distance indicator or a part thereof is connectable to the mobile radiation device, connectable to the surface of the substrate, connectable to a stationary base coupled to the mobile radiation device, connectable to a stationary base coupled to the substrate, connectable to a stand-alone stationary base, or a combination thereof.

In the kit disclosed herein, the distance indicator (5) can comprise a visual signal device for generating a visual signal, an audio signal device for generating an audio signal, a vibration signal device for generating a vibration signal, a digital signal device for generating an electronic signal, or a combination thereof.

The kit can further comprise:

iv) a motion support device (31) that is connectable to the mobile radiation device, wherein the motion support device (31) is configured to maintain the actual distance within a predetermined distance tolerance range of the pre-determined curing distance while the mobile radiation device is moving along the surface of the substrate.

Any of the aforementioned motion support devices can be suitable.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A process for producing a dry coating layer over a coated area of a substrate, said process comprising the steps of:
A) irradiating a first portion of a wet coating layer over said coated area with a mobile radiation device, said wet coating layer is formed from a radiation curable coating composition applied over said coated area of said substrate; and
B) irradiating one or more subsequent portions of said wet coating layer by moving said mobile radiation device from said first portion to said one or more subsequent portions, and optionally repeating irradiating said first portion and said one or more subsequent portions, until said wet coating layer is irradiated for a predetermined curing time to form said dry coating layer;
wherein said mobile radiation device is moved at a predetermined linear velocity along the surface of said substrate at a predetermined curing distance between said mobile radiation device and the surface of said substrate; and
said mobile radiation device produces radiation having peak radiation wavelength in a range of from 250 nm to 450 nm and has a peak irradiation power in a range of from 0.5 W/cm² to 10 W/cm².

2. The process of claim 1, wherein said wet coating layer is irradiated at a pre-determined radiation energy in a range of from 100 mJ/cm² to 2000 mJ/cm² measured at the surface of said substrate.

3. The process of claim 1, wherein said predetermined curing distance is in a range of from 1 cm to 50 cm.

4. The process of claim 1, wherein said curing time is in a range of from 10 second to 20 minutes.

5. The process of claim 1, wherein said predetermined linear velocity is in a range of from 1 cm/second to 100 cm/second.

6. The process of claim 1 further comprising the step of:
C) generating a distance signal using at least one distance indicator indicating a difference between said pre-determined curing distance and an actual distance between said mobile radiation device and the surface of said substrate.

7. The process of claim 6, wherein said distance signal is generated by a distance determination process comprising the steps of:
C1) measuring said actual distance between said mobile radiation device and said surface of said substrate using a distance measuring device; and
C2) comparing said actual distance with said pre-determined curing distance to generate said distance signal.

8. The process of claim 7, wherein said distance measuring device is selected from an ultrasonic distance measuring device, an optical distance measuring device, a laser distance measuring device, a radar distance measuring device, or a combination thereof.

9. The process of claim 7 further comprising the step of:
D) providing motion to said mobile radiation device moving along said surface of the substrate based on said distance signal maintaining said actual distance within a predetermined distance tolerance range of said pre-determined curing distance.

10. The process of claim 9, wherein said mobile radiation device is configured to be affixed to a motion support device that is configured to support said mobile radiation device and provide motion to said mobile radiation device at said predetermined linear velocity and within said predetermined distance tolerance range based on said distance signal.

11. The process of claim 1, further comprising the steps of:
A1) applying a curing indicator on the surface of said substrate before the step A);
A2) irradiating said curing indicator with said mobile radiation device at said predetermined curing distance for said predetermined curing time;
A3) measuring one or more measured curing characteristics of said curing indicator and comparing said one or more measured curing characteristics with one or more predetermined curing characteristics to produce curing difference data values;
A3i) determining that said curing difference data values are not within a predetermined curing tolerance range;
A4) adjusting said curing time to produce an adjusted curing time, adjusting said curing distance to produce an adjusted curing distance, or a combination thereof, abased upon the determination that said curing difference data values are not within the predetermined curing tolerance range;
A5) optionally, repeating the steps of A1)-A4) to produce subsequent adjusted curing time, subsequent adjusted curing distance, or a combination thereof until curing difference data values are within said predetermined curing tolerance range; and
A6) continuing to the step A) and subsequent steps by replacing said curing time with said adjust curing time or said subsequent adjusted curing time if present, replacing said curing distance with said adjusted curing distance or said subsequent adjusted curing distance if present, or a combination thereof.

12. A smart radiation curing system comprising:
(a1) a mobile radiation device (3);
(a2) a power and control unit (4) coupled to said mobile radiation device; and
(a3) at least one distance indicator (5) for generating a distance signal based on a pre-determined curing distance and an actual distance between said mobile radiation device and the surface of a substrate.

13. The system of claim 12, wherein said distance indicator (5) comprises a visual signal device for generating a visual signal, an audio signal device for generating an audio signal, a vibration signal device for generating a vibration signal, a digital signal device for generating an electronic signal, or a combination thereof.

14. The system of claim 12, wherein said distance indicator or a part thereof is affixed to said mobile radiation device, capable of being positioned on the surface of said substrate, capable of being positioned at a stationary base coupled to said mobile radiation device, capable of being positioned at a stationary base coupled to said substrate, or a combination thereof.

15. The system of claim 12, wherein said at least one distance indicator (5) comprises a display device, a wired or wireless network device, or a combination thereof.

16. The system of claim 12, wherein said at least one distance indicator (5) comprises at least a distance measuring device (50) for measuring said actual distance between said mobile radiation device and the surface of said substrate, said distance measuring device is selected from an ultrasonic distance measuring device, an optical distance measuring device, a laser distance measuring device, a radar distance measuring device, or a combination thereof.

17. The system of claim 16 further comprising:
(a4) a motion support device that is coupled to said mobile radiation device, wherein said motion support device is configured to maintain said actual distance within a predetermined distance tolerance range of said pre-determined curing distance when said mobile radiation device is moving along said surface of the substrate.

18. The system of claim 17, wherein said motion support device is a guiding rail device, an arm device, or a combination thereof, wherein said motion support device is configured to fit the surface geometry of said substrate.

19. A kit for a smart radiation curing system, said kit comprising:
i) a mobile radiation device (3);
ii) a power and control unit (4) connectable to said mobile radiation device; and
iii) at least one distance indicator (5) for generating a distance signal based on a pre-determined curing distance and an actual distance between said mobile radiation device and the surface of a substrate;
wherein said distance indicator or a part thereof is connectable to said mobile radiation device, connectable to the surface of said substrate, connectable to a stationary base coupled to said mobile radiation device, connectable to a stationary base coupled to said substrate, connectable to a stand-alone stationary base, or a combination thereof.

20. The kit of claim 18 further comprising:
iv) a motion support device that is connectable to said mobile radiation device, wherein said motion support device (31) is configured to maintain said actual distance within a predetermined distance tolerance range of said pre-determined curing distance while said mobile radiation device is moving along said surface of the substrate.
